(19) United States
(12) Patent Application Publication
(10) Pub. No.: US 2009/0019053 A1
(43) Pub. Date: Jan. 15, 2009

(54) METHOD FOR SEARCHING FOR AND MARKETING FASHION GARMENTS ONLINE

(75) Inventors: David Burgess, Menlo Park, CA (US); Shyam Kapur, Sunnyvale, CA (US); Caitlin Smallwood, Palo Alto, CA (US)

Correspondence Address: Yahoo! Inc., c/o Kenyon & Kenyon LLP, 333 W. San Carlos Street, Suite 600, San Jose, CA, 95110, US

(73) Assignee: YAHOO! INC., Sunnyvale, CA (US)

(21) Appl. No.: 11/777,580

(22) Filed: Jul. 13, 2007

(51) Int. Cl. G06F 17/30

(52) U.S. Cl. 707/10; 707/E17.138

(57) ABSTRACT

A method of generating clothing recommendations for a potential purchaser uses user-specific information to generate a list of suggested garments for the user and displays a graphical representation of the garments. The user-specific information may include recommendations from one or more friends, fashion experts, or other purchasers, optionally including information based on purchasing history or shopping history of other purchasers. The graphical representation may include a three-dimensional representation. Recommendations may be prioritized based on ranking.

### BACKGROUND

1. Field of the Invention

Aspects of the present invention relate generally to a method for searching for, marketing, and purchasing fashion garments online.

2. Description of Related Art

Presently, when one wants to purchase new clothes, one either has to go into a store and try the clothes on or purchase the garments from an online retailer. Both can take a considerable amount of time and the purchaser risks the possibility of missing out on something he may in fact really want, hut simply has not yet come across. Moreover, with regard to purchasing garments online, the purchaser is not always sure of what he is buying—unless he has previously purchased a garment in a particular size and style from a particular designer/manufacturer, he risks having the clothes not he what he was expecting (e.g., wrong color, size, style, fabric, etc.). Further, there is no automated way of insuring that the clothes “match,” as the word is generally understood in the fashion world, namely that the clothes are corresponding, suitably associated garments (where such association can be based on color, texture, material, etc.), generally worn together as an “outfit.”

The current process of searching for clothes online is somewhat rudimentary and usually occurs in one of two ways, both of which generally involve the user visiting the website of some brick-and-mortar establishment or a website that aggregates various brands. In the first experience, the user visits the website, browses it, and tries to pare down its offerings to exactly what they are looking for. For example, a woman may go to the website of a clothing manufacturer and be presented with a choice between men and women's clothes. If she chooses “women,” she may be presented with various categories of attire, such as, for example, “sweaters,” “jeans,” “socks,” etc. If she chooses “jeans” she may be presented with various brands of jeans, and if she chooses a particular brand, she may then choose a size, color, wash, etc. Finally, after making all of these decisions, she decides whether she wants to purchase any of the jeans she has been presented with.

In the second experience, the user visits the site and enters various search criteria, usually by selecting an option from a plurality of drop-down menus, whose options may or may not be updated to correspond to the other drop-down options already selected. For example, the front page of a site may have a drop-down for gender, another for clothing type (e.g., sweater, jeans, socks, etc.), another for size, another for color, etc. Finally, the site would attempt to search for garments that matched all of the search criteria.

In both experiences, the clothes are usually presented alone (i.e., not dressed on anything) or are shown on an actual human model, who may or [most likely] may not share the same physical characteristics as the user. Because of this limitation, the user is left to imagination how the clothes may look on him or her and therefore may make a ‘bad’ decision as to what he or she ultimately decides to buy. Further, the searches that are currently possible do not collectively consider past purchases, recommendations from other users/experts, whether the clothes being purchased actually match, unique size and dimensions of the user, the current season, user's feedback regarding previous purchases, etc.

So, while methods currently exist by which users can search for clothes of a certain size, color, etc., they are incredibly limiting and largely impersonal. Moreover, these searches do not necessarily allow the designer-manufacturer-distributor to market directly to the consumer. Thus, it is desirable to improve the process of searching for and purchasing clothes online, and to help designers, manufacturers, and distributors better market their clothes to potential purchasers.

### SUMMARY

In light of the foregoing, it is a general object of the present invention to provide a more accurate way of searching for, and presenting to potential customers, various articles of clothing online. It is another object of the invention to make it easier for designers, manufacturers, and distributors to market their wares to potential customers, and for such marketing to be more effective.

The foregoing and other aspects of various embodiments of the present invention will be apparent through examination of the following detailed description thereof in conjunction with the accompanying drawing figure

### BRIEF DESCRIPTION OF THE DRAWING FIGURES

FIG. 1 is a simplified block diagram illustrating operation of one embodiment of a method of searching for and purchasing clothes online.

### DETAILED DESCRIPTION

Detailed descriptions of one or more embodiments of the invention follow, examples of which may be graphically illustrated in the drawing. Each example and embodiment is provided by way of explanation of the invention, and is not meant as a limitation of the invention. For example, features described as part of one embodiment may be utilized with another embodiment to yield still a further embodiment. It is intended that the present invention include these and other modifications and variations.

In all embodiments there exists a “user profile,” which stores various information about the user relevant to shopping for clothes online—“user-specific information.” Such information can be thought of as including “personal information” and “non-personal” information. Personal information may include the user's body type, body dimensions, skin color, past purchasing histories, etc., and non-personal information is everything else that may be relevant to providing the user with satisfactory clothing suggestions (e.g., the type or color of clothing the user is presently looking for, etc.).

Throughout this description, reference is made to the “system,” which is used to denote the machine or machines responsible for storing, and serving (e.g., a web server delivering web pages), all of the clothing information and user profiles, and a user application (e.g., a web browser) for interacting with, and displaying, the suggested clothes and advertisements.

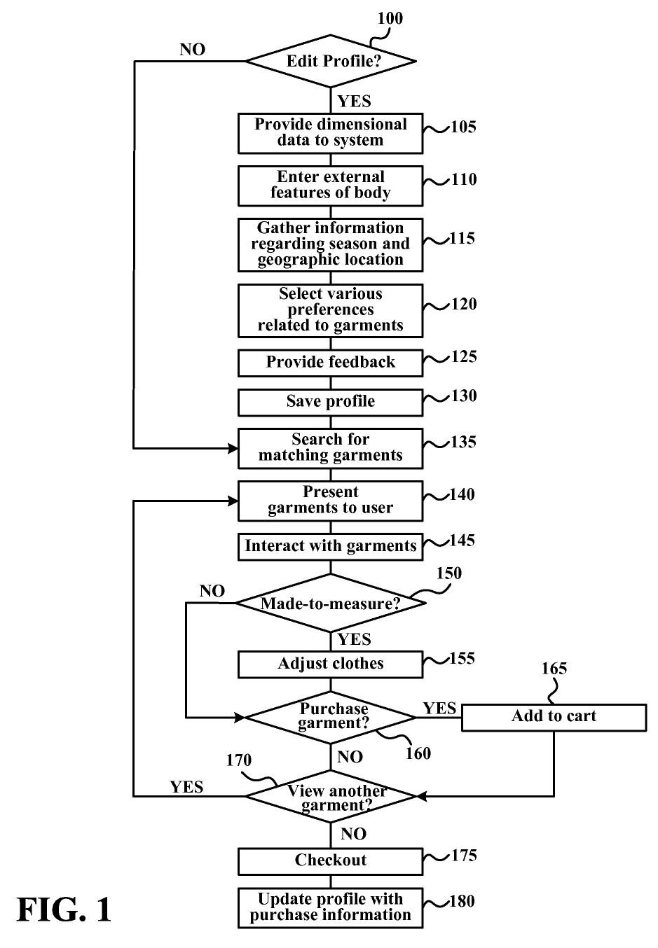

FIG. 1 details a particular flow of the invention and will be referred to throughout this description. FIG. 1 assumes that a user is interacting with the invention through a user application. At decision block 100, a user is asked whether he wants to edit his profile. If “yes,” then he is allowed to edit any of the attributes discussed infra. If “no,” he is shown those clothes recommended by the system based on the attributes found in his user profile, historical data about the user and the “suggested garments” discussed below. It will be appreciated that such “asking” need not occur in such a ‘strict’ form and may take any form which allows the user to change his profile (e.g., by having such profile information in a window separate from the clothes, or by having such profile information within an element of a web page separate from the clothes, etc.). In other words, it need not be a separate step, but can instead be thought of as inline with the rest of the process and editable at any time.

Next, at block 105, various physical dimensions of the user—part of the “personal information”—are entered into the user profile. The dimensional information includes data related to the user's physical size and shape, and may be relayed to the system in a variety of ways. One such way involves uploading to the system a 3-D scan of the user's body, such scan being done at any of a number of facilities around the country. If such a facility is not readily available to the user, he may simply enter his body dimensions into the system through the user application, where such dimensions may include measurements for feet, waist, height, weight, shoulders, chest, upper arms, thighs, etc., to whatever level of granularity is required, as a function of the closeness of the desired fit.

Using this information, the system can create a 3-D model of the user. The more values the user can give the system, the more accurate the derived model will be. For example, a user with unusually long legs who enters his height as 6′ may be depicted as an average 6′ man (i.e., his legs would not look unusually long). However, if the same user, in addition to specifying his height (and possibly his inseam), also specified the distance between his waist and knees, and the distance between his knees and feet, the system would have much more information to work with and the model would ultimately be more accurate.

In addition to the size traits mentioned above, at block 110 the user may also enter other personal information regarding various other external traits, such as, for example, skin color, eye color, hair style/color, glasses or no glasses, etc. All of this information further informs the system and allows it to create both better 3-D models of the users (thereby enabling them to better visualize how clothes may look on them) and more accurate clothing recommendations (e.g., a particular shirt can be found to accent the user's eyes, etc.). The system may incorporate multiple objects to represent various styles of these external traits. For example, the system might include 50 types of glasses, or 25 female hairstyles, or 30 shades of skin color, etc.; the user may be given an opportunity to pick any of these for his or her model. In another instance, the user may simply claim his various traits from a drop-down list of text-based descriptions and then the system may provide whatever object it uses for each of those traits (e.g., the system may contain only a single pair of glasses that it uses for all models, etc.).

Like all other profile information, these values can be changed at any time so as to build the model as accurately as possible for the event, season, etc. for which clothes are being recommended. For example, the user may wish to find clothes to wear to a club or bar (i.e., places the user likes to frequent with her hair done a certain way). In such a case, the user could choose that particular hairstyle along with other descriptors detailing what type of clothing she is looking for (i.e., those for a club or bar) and be shown the suggested clothes on a model of her with that particular hairstyle.

Additionally, as shown at block 115, the user profile may include such non-personal information as the season of the year (as entered by the user or determined from the date) and geographic location (as entered by the user or inferred from the IP address or profile of the user). Further, at block 120, various other non-personal information regarding clothing preferences may be stored in the user profile, such as, for example, a theme category (e.g., formal, casual, workout, etc.), a brand category (e.g., Lacoste™, Hugo Boss™, etc.), material preferences (e.g., leather, satin, cotton, etc.), etc. A color [palette] preference may also be saved in the user profile. Ultimately, the user profile serves as a repository for some or all descriptors that can help the system to provide the most relevant and applicable clothing to the user, help experts and other users give recommendations to this user and groups of users, help clothing advertisers reach a more targeted audience and help search engines give recommendations based on aggregated user profiles and user recommendations.

Again, it will be appreciated that any of the user profile values can be changed at any time. For example, the user may choose to search for a business suit one day and a bathing suit the next; or, as is apt to happen, the user may gain or lose weight, in which case he can update his dimensional information to follow such fluctuations.

Block 125 refers to the ability to leave feedback regarding various elements of the user's purchases, including feedback regarding the items purchased and feedback regarding those other users or experts who may have recommended the clothes to the user, and is discussed in further detail below.

At Block 130, the various settings can be saved to the user profile. Again, as above, these settings can be saved or updated in real-time as changes are made to the profile and do not necessarily require a distinct “save” request by the user. After these settings have been saved to the user profile, a search of the system may be performed at block 135, using all available information from the user profile.

The results of the search—the suggested garments—can be based on various things, some of which may be interrelated and interdependent. In one embodiment, the suggested clothes may be recommended by an “expert,” whose job may be to make these sorts of recommendations for users of the system. In the same vein, other users of the system who have been given permission, by the user running the search, to access parts of his/her user profile needed to make a recommendation, may make such a recommendation; these users can be considered “friends” of the searching user, and the relationship can be stored in the user profile for future use by the system and the user. The user or system may alert friends of the searching user to let them know that their assistance is requested (e.g., via notification or alerting through e-mail. Instant Messenger, etc.). Similarly, experts may also be notified when a user makes a search. The user may rate or rank their friends, other users and the experts' recommendations, such information to be not only stored in his user profile, but also aggregated with other users of the system so as to use the “wisdom of the crowds” to bring the “best” users and experts to the forefront so that users of the system can continuously find other people's recommendations to help them with their clothing searches.

In another embodiment, the user's historical data—that is, data regarding the user's purchasing/searching habits that has been accumulated over time—may be used to help the system find relevant clothing. Such information can be derived from a combination of any of the personal and non-personal information stored in a user profile, such as, for example, how many times the user has searched for a particular brand of shirt in the last 12 months, or requested recommendations from a particular expert, or purchased jeans that cost less than $150, etc.

In yet another embodiment, the expert and user recommendations of clothes and combinations of clothes can be made to users that have shown or show preference in particular clothing styles, theme categories, brand categories, etc.

Historical data may also include feedback the user reports to the system after receiving clothes she has purchased. For example, if the user orders a particular brand of shirt and finds that it fits her perfectly, she may update her user profile (e.g., flag that brand and size as a “favorite,” etc.). Another example might be where an expert recommended an outfit that she particularly enjoyed; in such an instance she may wish to rate or rank this expert or expert's opinion very highly and request his recommendation in the future, or suggest the expert to friends, etc.

The user may also add to her profile feedback regarding existing clothes, even those she did not purchase through the system, so as to further inform the system of her likes and dislikes. The user may also want to allow her friends to comment on and “rate” her clothes. The system can use all of this data to further filter the suggested garments in the next iteration of the search.

In yet another embodiment, the clothes are suggested through a matching algorithm, which takes all of the available information in the user profile and attempts to gather clothes, or even complete outfits, that correspond to what the user is looking for. Because some users have difficulty matching articles of clothing, or do not have the time to learn what goes with what, etc., the matching program can help them with that, or can generally help anyone, even those proficient with fashion “rights,” to find clothes they might not come across otherwise.

The matching algorithm can be informed by general rules (e.g., all t-shirts “go with” all jeans, or these shoes “go with” all jeans, or this color “goes with” that color, etc.) or explicit relational rules between particular items (e.g., this particular shoe goes well with this particular dress, etc.). These rules can be “added” to the system by the system operator, the user, the user's friends, the experts, the system itself after noticing a rule being repeatedly added by users of the system, etc., but they are ultimately transparent to the user. In other words, when the user runs a search based on his user profile, he need not concern himself at all with the matching algorithm—it will run, using all the information it has (i.e., information from the user profile, the rules that have already been added, etc.), to aggregate the most accurate clothes it can.

As mentioned, in one instance, the matching algorithm can find a single garment to match another garment. For example, the user may have just found, through a previous iteration of the search, a top that she likes. She could then ask the system to find her a bottom that matches the top. The matching algorithm would then try to find her a bottom that both met the criteria in her user profile and matched the top. In another instance, the matching algorithm may be used to find an entire ensemble. For example, the user may specify only that she is looking for a business outfit. The matching algorithm could then suggest complete outfits, including matching shoes, pants, shirts, socks, etc.

The matching algorithm may also allow the user to select how she wants the list of suggested garments sorted. For example, the user may wish to be shown only those garments previously suggested for other users by a friend of hers or expert, in descending order of the number of times the friend or expert suggested the particular garment. As another example, the user may wish to sort the garments relative to how well the system thinks they are aligned with her user profile. In still another example, the user may wish the list of suggested garments to be sorted by the date in which they were added to the system (i.e., to be shown the newest items first). In yet another example, the user may wish to take advantage of the “wisdom of the crowds” and list the suggested garments by the aggregated rating or recommendations of many other users.

Again, it will be appreciated that the combination of any of the embodiments detailed above is both possible and desired, so as to be able to provide the user the most effective shopping experience, the advertiser the most effective advertising campaign (as discussed below), and the distributor, manufacturer, and designer the most effective selling effort. Thus, in one embodiment, all of these searching/matching features are used together, but when any of them is unavailable, the system may make the best use of those that are available.

After the search is complete, the list of found garments is presented to the user at block 140. The results of the search—again, the suggested garments—will satisfy, to the extent possible, the criteria in the user's profile. These suggested garments may be presented to the user with or without the aid of a model, depending both on user preference and whether the system has 3-D information for the particular garment. For example, if the user prefers to not have the suggested garments displayed on a 3-D model, they may be presented as a visual or text-based list. Such a list may include all of the garments found or may be broken up into various categories based on the settings from the user profile used to conduct the search, to the extent that such results lend themselves to being further categorized. For example, if the user is looking for clothes identified as “business” garments, the system may divide the suggested garments into multiple sub-themes or sub-categories, such as, for example, “business casual,” and “formal.” The user may be presented with both and then can choose which she would like to view.

Where the user prefers to see the garments on her 3-D model, the suggested garments may be automatically displayed on the model and the user allowed to scroll/click through them. Where the user is using the 3-D model to view the garments, the user is able to rotate the model so as to see the clothes from all angles. Further, the user is allowed to change the size, color, etc. as desired (to the extent the designer/manufacturer/distributor offers another size, color, etc.).

Also, for made-to-measure clothes (i.e., those that can be custom tailored before being sent to the user), as illustrated in block 150, the user may, at block 155, make alterations on the screen (e.g., bring in the waist on a shirt, adjust the hem on a pair of pants, etc.) to better fit the displayed model.

It may not always be the case that 3-D information is available for a particular garment. Availability can depend on the garment manufacturer; if the manufacturer does not provide 3-D descriptions of the clothing, then 3-D display may not be possible. Where no 3-D information is available, the usual 2-D image of the clothing (or an image of the clothing on a real model) still can provide accurate recommendations and advertisements (as discussed below) based on the user profile.

Also, in addition to presenting to the user the suggested garments, the system may provide advertisements to be presented alongside the garments; advertising display decisions could be a function of the information in the user's profile. For example, if the user's profile indicates that the user generally buys “professional” clothing from a particular brand, then the system could display advertisements for “professional” clothing. Also, such advertisements need not just be shown together with suggested garments, but rather may be shown on any user application (e.g., a general search application running on a web page) having access to the user profile. For example, if the maintainer of the system also maintains a web mail service used by the user, advertisements related to the user's search(es) or profile may be shown together with the user's e-mail. Such an example may be especially effective where the user spent a long time using the system to find a particular garment, but ultimately did not buy any of the suggested garments.

Finally, once a user decides she wants to buy a particular garment or outfit, she can simply select it for purchase at block 160, after which it may automatically be added to her “cart” at block 165. Next, at block 170, the user is asked if she would like to view another garment or outfit. If yes, the user is brought back to block 140, where she may be shown the next garment or outfit in the original list of suggested garments or outfits, or where another search may be run corresponding to the garment or outfit she just selected for purchase (e.g., if she selected a purse, the system might then suggest shoes to go with the purse). Once the user finishes or tires of cycling through the list of suggested garments or outfits, she may proceed to purchase the items, as illustrated at block 175. Upon searching, viewing and/or purchasing the garments or outfits, her profile may be updated, at block 180, with information about the purchase (e.g., cost, type of garment, brand, size, material, etc.) so as to further inform the system for future searches. This profile may or may not be visible to the user.

The sequence and numbering of blocks depicted in FIG. 1 is not intended to imply an order of operations to the exclusion of other possibilities. Those of skill in the art will appreciate that the foregoing systems and methods are susceptible of various modifications and alterations. For example, block 100, as illustrated in FIG. 1, may not require the user to make a selection at all. Instead, one embodiment may allow the user to constantly update his profile as he uses the system to view the results of his search. Also, for example, at block 150, the user's profile may explicitly state that he does not want to be shown any made-to-measure clothes or brand(s) or style(s), in which case, blocks 150 and 155 would not be utilized.

Several features and aspects of the present invention have been illustrated and described in detail with reference to particular embodiments by way of example only, and not by way of limitation. Those of skill in the art will appreciate that alternative implementations and various modifications to the disclosed embodiments are within the scope and contemplation of the present disclosure. Therefore, it is intended that the invention be considered as limited only by the scope of the appended claims.

What is claimed is:

1. A method of generating clothing recommendations for a potential purchaser; said method comprising;
receiving user-specific information;
storing said user-specific information in a computer-readable medium;
generating a list of suggested garments responsive to said receiving; and
causing a graphical representation of one or more of said suggested garments to be displayed.

2. The method of claim 1 wherein said generating comprises generating said list based on one or more recommendations from one or more friends of the potential purchaser.

3. The method of claim 1 wherein said generating comprises generating said list based on one or more recommendations from one or more fashion experts.

4. The method of claim 1 wherein said generating comprises generating said list based on one or more recommendations from one or more purchasers.

5. The method of claim 1 wherein said user-specific information comprises personal information about the potential purchaser.

6. The method of claim 5 wherein the personal information comprises physical attributes of the potential purchaser.

7. The method of claim 1 wherein said user-specific information comprises non-personal information.

8. The method of claim 7 wherein the non-personal information comprises attributes of one or more garments that the potential purchaser is seeking to purchase.

9. The method of claim 7 wherein the non-personal information comprises fashion trends.

10. The method of claim 9 wherein the fashion trends are seasonal.

11. The method of claim 7 wherein the non-personal information comprises the potential purchaser's geographic location.

12. The method of claim 1 wherein said graphical representation comprises a 3-dimensional model on which one or more of said suggested garments is superimposed.

13. The method of claim 12 wherein the 3-dimensional model is derived from the user-specific information.

14. The method of claim 12 wherein the 3-dimensional model is supplied by an external source.

15. The method of claim 1 wherein said generating comprises executing a matching algorithm to ensure that the list consists of suitably associated garments.

16. The method of claim 1 further comprising displaying advertisements substantially concomitantly with the suggested garments.

17. The method of claim 16 wherein the advertisements are generated using information selected from the group consisting of the user-specific information, geographic information, and historical user information.

18. The method of claim 1 wherein one or more of the suggested garments can be custom tailored.

19. The method of claim 12 further comprising shaping one or more of the suggested garments to fit the 3-dimensional model.

20. The method of claim 1 wherein the user-specific information comprises information selected from the group consisting of the purchasing history of the potential purchaser and the searching history of the potential purchaser.

21. The method of claim 2 wherein the user-specific information comprises a rating or ranking of said friends to prioritize said one or more recommendations.

22. The method of claim 3 wherein the user-specific information comprises a rating or ranking of said fashion experts to prioritize said one or more recommendations.
